(19) United States
(12) Patent Application Publication
(10) Pub. No.: US 2008/0052862 A1
(43) Pub. Date: Mar. 6, 2008

(54) Wiper for an automobile rearview mirror

(76) Inventor: Chiang-Fen Lin, Yongkang City (TW)

Correspondence Address: CHIANG-FEN LIN, P.O. BOX 90, Tainan City, 70499, omitted

(21) Appl. No.: 11/514,858

(22) Filed: Sep. 5, 2006

(51) Int. Cl. B60S 1/56; B60S 1/60; B60S 1/26

(52) U.S. Cl. 15/250.003; 15/250.3; 15/250.48; 15/250.351

(57) ABSTRACT

A wiper for an automobile rearview mirror includes a transmitting device, a connect rod and a wiper. The transmitting device is fixed on a rear side of the rearview mirror, composed of a motor, a drive worm fixed on the spindle of the motor, and a speed-changing gear unit engaging with the drive worm. The speed-changing gear unit consists of two shafts intercrossing each other for several gears fixed thereon and engaging with one another so that a drive gear fixed on a rotary shaft can be rotated by the transmitting device. The connect rod is fixed with the rotary shaft and then the wiper is fixed on the connect rod. Then the wiper is swung up and down together with the connect rod and the rotary shaft driven by the transmitting device, cleaning off water drops on the rearview mirror.

### BACKGROUND OF THE INVENTION

1. Field of the Invention

This invention relates to a wiper for an automobile rearview mirror, particularly to one provided with a wiper fitted on a connect rod fixed with a rotary shaft driven by a transmitting device so that the wiper can be swung up and down by the connect rod and the rotary shaft together on the surface of a mirror body for cleaning water drops off the rearview mirror, enabling a driver to look clearly on the images reflected on the rearview mirror.

2. Description of the Prior Art

In driving, a driver has to watch the right and the left rearview mirror to check the traffic condition behind his/her automobile so that he/she may be able to make a turn, overtake other automobiles, changing a lane or parking, if necessary. However, the rearview mirrors are positioned outside the automobile, so they are to be drenched in rain, blurring its surface owing to many raindrops remained on the surface of the rearview mirrors. Then a driver cannot see clearly the images reflected thereon, impossible to drive with safety.

### SUMMARY OF THE INVENTION

The purpose of the invention is to offer a wiper for an automobile rearview mirror for cleaning off water drops off a rearview mirror of an automobile so that a driver can see clearly the images reflected on it for driving with safely.

The features of the invention are a transmitting device, a connect rod and a wiper. The transmitting device is fixed on a rear side of the mirror base of a rearview mirror, composed of a motor, a drive worm fixed on the spindle of the motor, a speed-changing gear unit engaging with the drive worm of the motor and a rotary shaft. The speed-changing gear unit consists of a first shaft and a second shaft, the first shaft fixed with a drive worm gear and a driven worm, with the drive worm engaging with the drive worm of the motor, and the second shaft fixed with a driven worm gear and a drive gear. The rotary shaft has a driven gear engaging with the drive gear, extending on a front side of the rearview mirror. The connect rod is fixed on the rotary shaft to be swung together by the transmitting device. The wiper with an elastic member inside is fitted with the connect rod, and closely contacts the surface of the rearview mirror so that the wiper may be swung up and down closely on the surface of the rearview mirror when swung up and down by the connect rod.

### BRIEF DESCRIPTION OF DRAWINGS

This invention will be better understood by referring to the accompanying drawings, wherein:

FIG. 1 is a front perspective view of an automobile rearview mirror with a wiper in the present invention;

FIG. 2 is a rear perspective view of the automobile rearview mirror with a wiper in the present invention;

FIG. 3 is an exploded perspective view of a transmitting device of a wiper in the present invention;

FIG. 4 is a side cross-sectional view of the wiper in the present invention;

FIG. 5 is a front view of the wiper in a first moving condition in the present invention;

FIG. 6 is a front view of the wiper in a second moving condition in the present invention;

FIG. 7 is a front view of the wiper in a third moving condition in the present invention; and,

FIG. 8 is a side cross-sectional view of the wiper in the present invention, showing a gap formed between a mirror body and the wiper.

### DETAILED DESCRIPTION OF THE PREFERRED EMBODIMENT

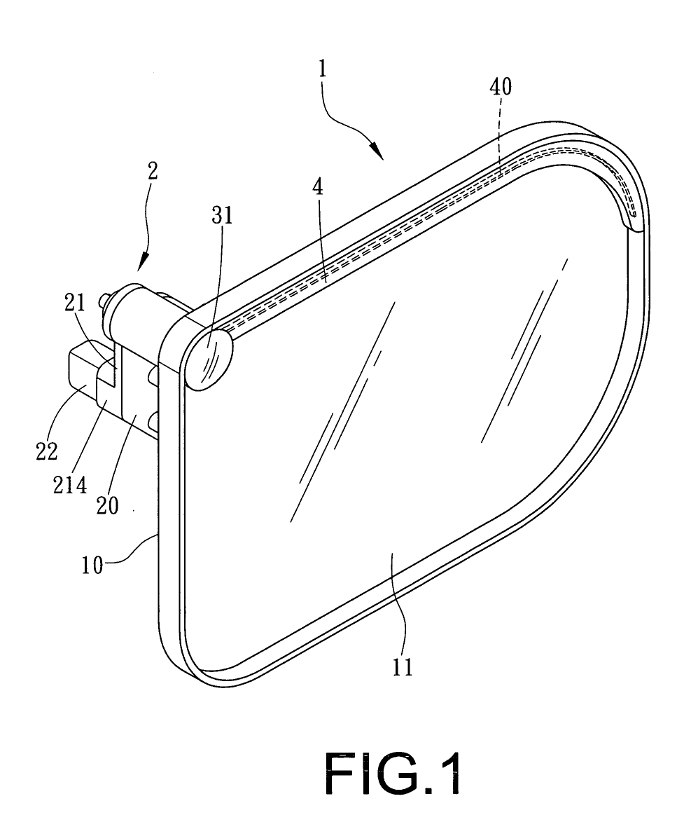

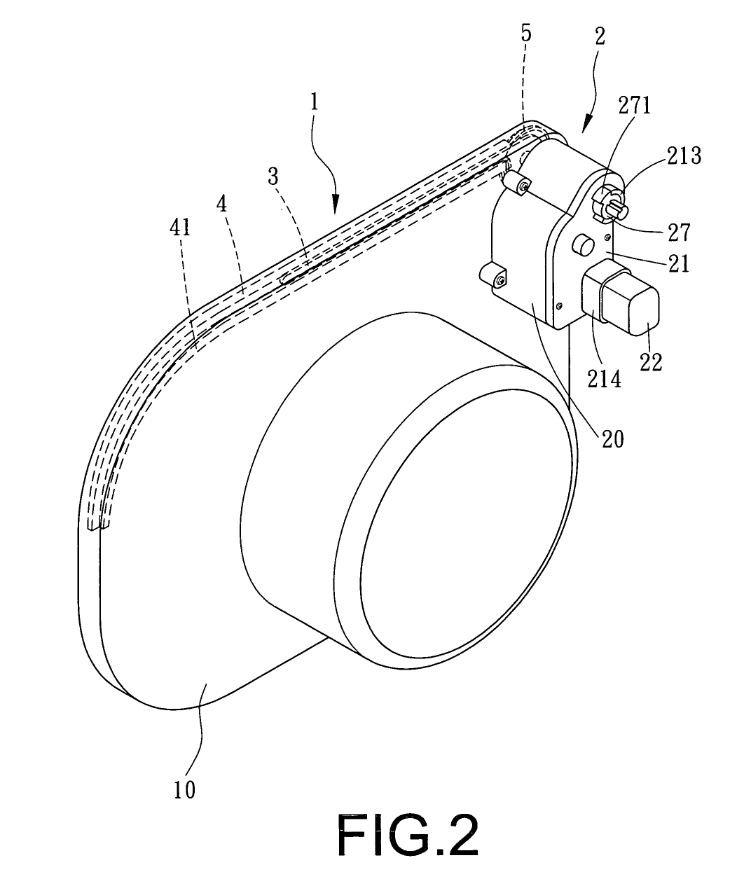

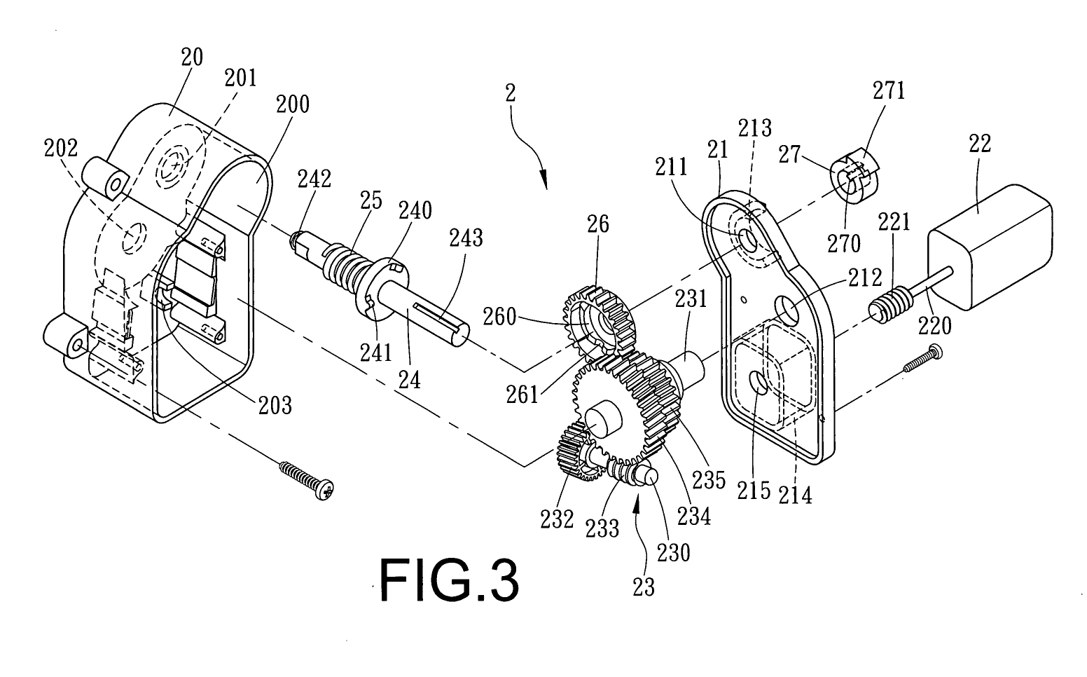

A preferred embodiment of a wiper for an automobile rearview mirror in the present invention, as shown in FIGS. 1-4, includes a rearview mirror 1, a transmitting device 2, a connect rod 3, and a wiper 4 as main components combined together.

The rearview mirror 1 is provided with a base 10, and a mirror body 11 fixed on a front side of the base 10, and a shaft hole 12 bored through the mirror body 11 to the rear side of the base 10.

The transmitting device 2 is composed of a shell 20, a cap 21 closed on an open vertical side of the shell 20, a motor 22, a speed-changing gear unit 23, a rotary shaft 24, a coiled spring 25, a driven gear 26, and a stopper 27.

The shell 20 is provided with a chamber 200 and s shaft hole 201 in a rear side and a position hole 202 also in the rear side below the shaft hole 201 and a position member 203 fixed sidewise on the rear side.

The cap 21 is provided with a shaft hole 211 to correspond to the shaft hole 201 of the shell 20, a position hole 212 to correspond to the position hole 202 of the shell 20, a stop block 213 protruding on an outer wall, a motor base 214 formed to protrude on the outer wall below the stop block 213 and provided with a hole 215.

The motor 22 is combined on the motor base 214, having a spindle 220 and a drive worm 221 fixed on the spindle 220, with the drive worm 221 extending in the hole 215 of the motor base 214 and also in the chamber 200 of the shell 20.

The speed-changing gear unit 23 is installed in the chamber 200 of the shell 20, composed of a first and a second shaft 230 and 231 intercrossing with each other, a drive worm gear 232 and a driven worm 233 fixed on the first shaft 23, with the drive worm gear 232 engaging with the drive worm 221. A driven worm gear 234 and a drive gear 235 are fixed on the second shaft 231, with the driven worm gear 234 engaging with the driven worm 233. The first shaft 230 is positioned on the position member 203 in the chamber 200, and the second shaft 231 has two ends respectively fitting in the position holes 202 and 212 of the shell 20 and the cap 21 respectively, located between the shell 20 and the cap 21.

The elongate rotary shaft 24 extends through the shaft holes 201 and 212 of the shell 20 and the cap 21 respectively, provided with a flange 240 in an intermediate portion, plural sidewise projections 241 formed around on an right side of the flange 240, an annular groove 242 formed in a left (first) end, and a lengthwise slot 243 formed in the right (second) end portion.

The coiled spring 25 is fitted around the intermediate portion of the rotary shaft 24 behind the flange 240, having a first end pushing against the inner wall of the chamber 200 and a second end urging on the left side of the flange 240, The driven gear 26 is fitted around the second end portion of the rotary shaft 24, provided with a recess 260 for receiving the flange 240 therein, and the recess 260 is provided with plural fit groove 261 in an inner wall for the sidewise projections 241 to fit therein.

The stopper 27 is fixed on the second end of the rotary shaft 24, provided with an inner projection 270 fitting movably in the slot 243, and an outer projection 271 contacting closely the stop block 213 of the cap 21. Further the rotary shaft 24 also extends out of the shaft hole 12 of the mirror body 12.

The connect rod 3 is fixed around the annular groove 242 of the first end of the rotary shaft 24 by means of a fastening member 31, located on an outer surface of the mirror body 11, and provided with a shaft hole 30 for the rotary shaft 24.

The wiper 4 is fixed lengthwise on the connect rod 3, made of soft material, and an elastic member 40 is wrapped in the wiper 4 to enable the wiper 4 flexible to bend and straighten again after bent. Further the wiper 4 has a lengthwise wiping surface 41 closely contacting the surface of the mirror body 11.

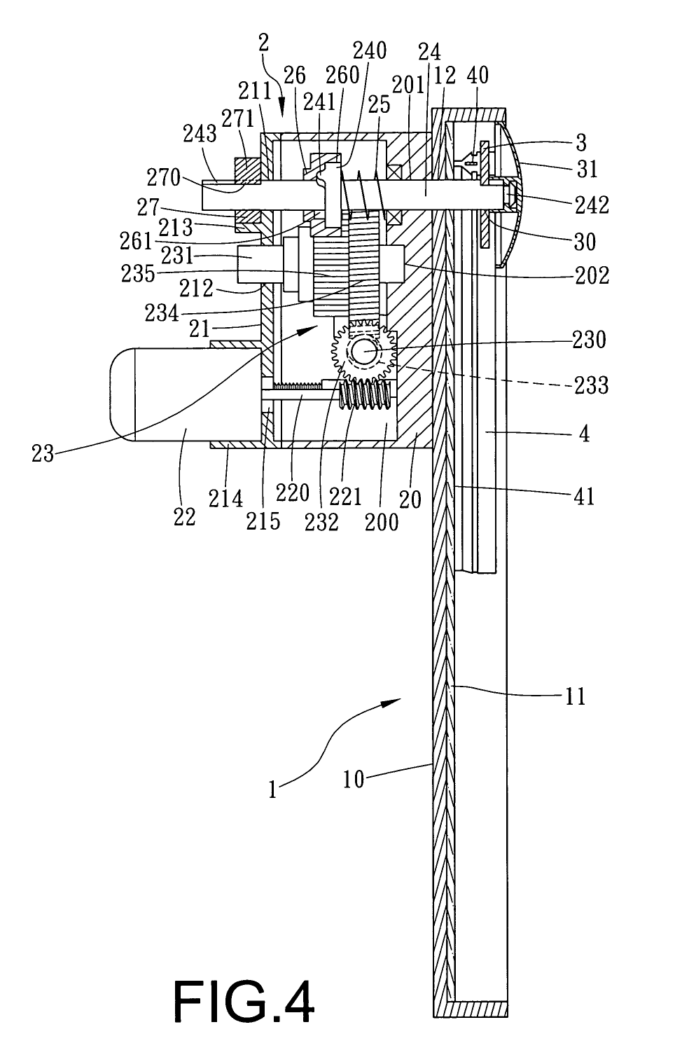

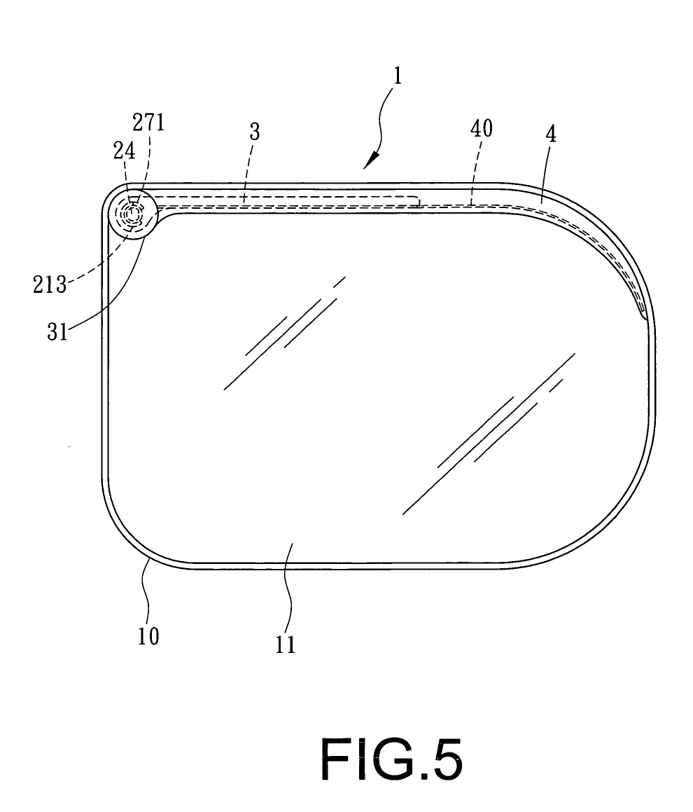

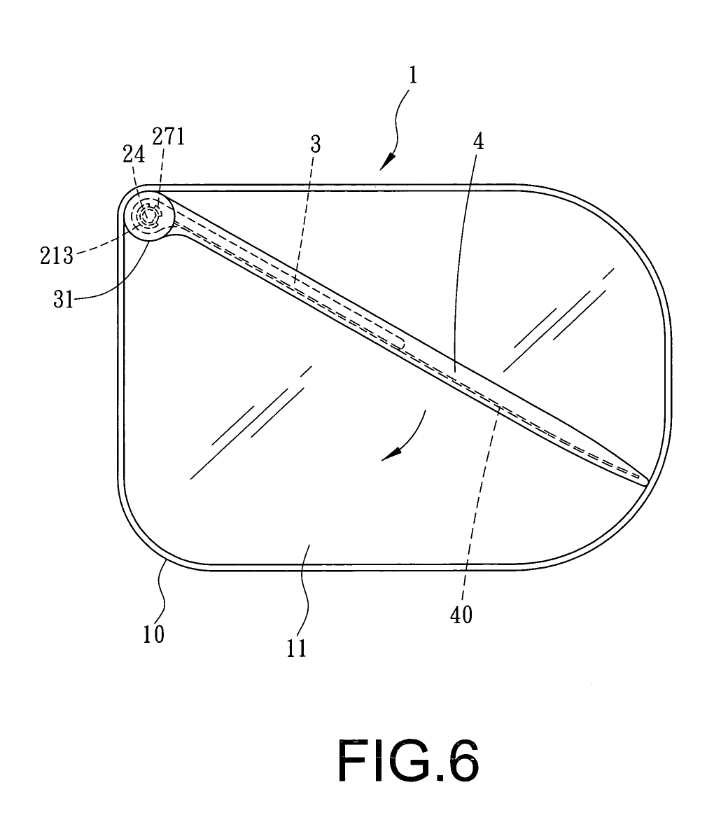

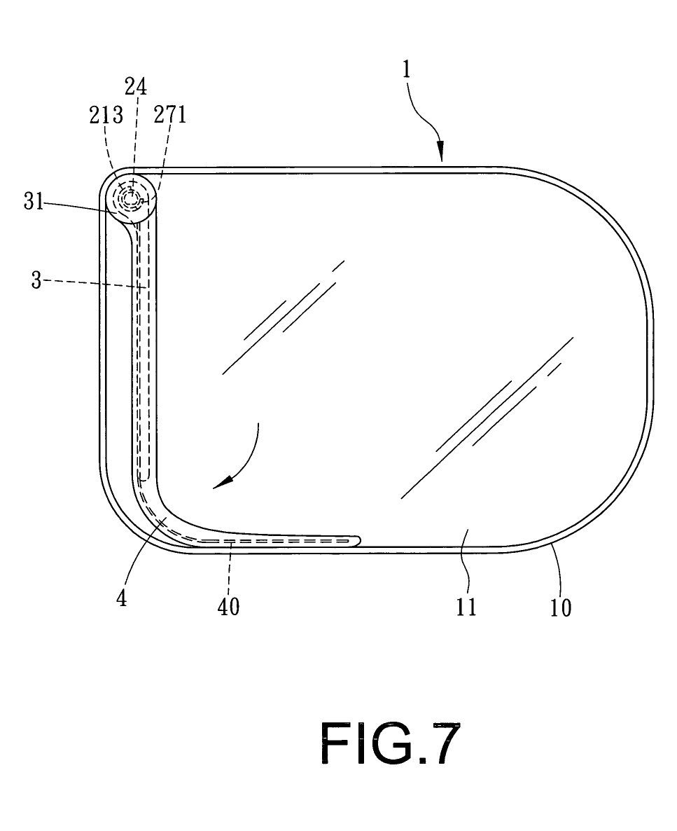

In using, as shown in FIGS. 4-7, when raindrops on the mirror body 11 of the rearview mirror 1 is wanted to be cleaned, start the motor 22 to rotate the drive worm 221, which then drives the driven worm 233 via the first shaft 230. Then the driven worm 233 rotates the driven worm gear 234 on the second shaft 231, which then drives the drive gear 235 and then the drive gear rotates the driven gear 26 on the rotary shaft 24. So the rotary shaft 24 is rotated by the driven gear 26, swinging the connect rod 3, which then swings the wiper 4. Then the wiper 4 may swing together with the connect rod 3 from the upper edge of the mirror body 11 to the lower edge, and then the wiper 4 is to straighten from the bent condition at the upper edge, as shown in FIG. 6, and then moves down to be stopped by the lower edge and bend again to curve along the lower edge owing to the flexibility of the elastic member 40, as shown in FIG. 7. At this time, the stopper 27 of the rotary shaft 24 has its outer projection 271 resting against the stopping member 213 of the cap 21, stopping the rotary shaft 24 immovable, so the motor 22 continues to operate, enlarging the torque to force the motor 22 to reverse rotating direction so that the rotary shaft 24 is then rotated reversely. Therefore, the wiper 4 also swings reversely upward, and cleans raindrops off the mirror body 11 to reach the upper edge of the mirror body 11 again and forced to elastically bend along the upper edge again. Then the wiper 4 is forced by the reverse operation of the motor 22 to swing down again, thus reciprocating on the mirror body 11, cleaning water drops off, if there is any. In this way, a driver can see clearly the image reflected on the cleaned mirror body 11.

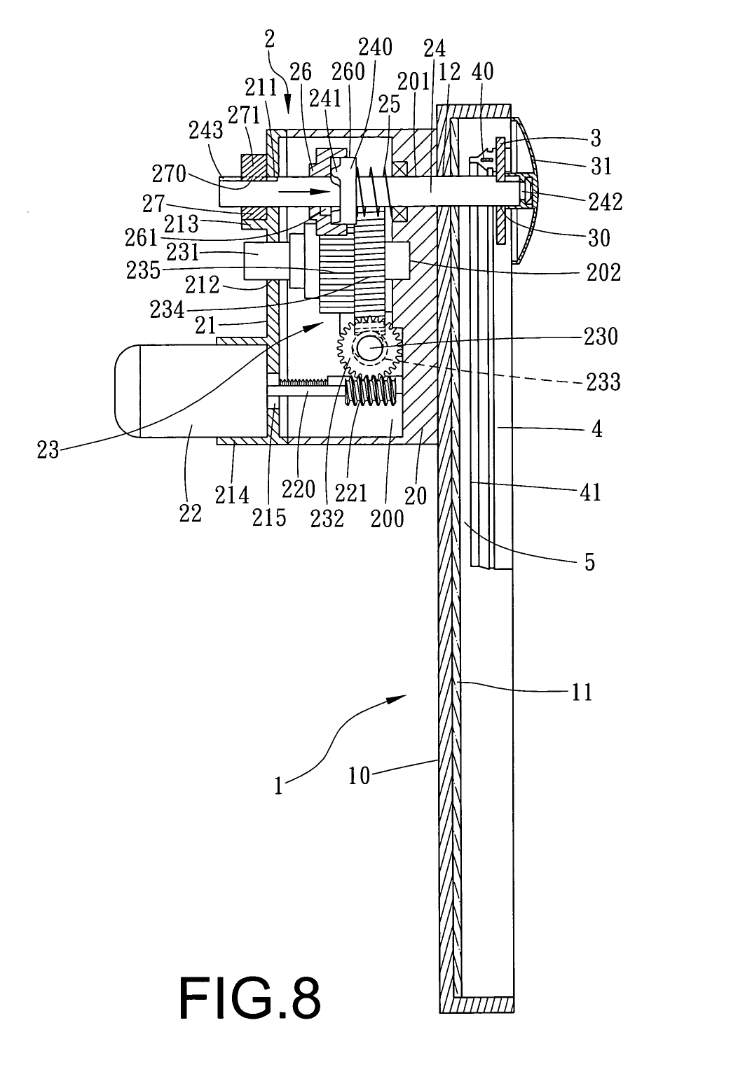

On the contrary, if the wiper 4 is not to be used, handle the motor 22 to rotate the wiper 4 to rest at the upper edge of the mirror body 11, as shown in FIGS. 4, 5 and 8. In this process, the driven gear 26 on the rotary shaft 24 is rotated for a bit only, and the rotary shaft 24 becomes impossible to move, restricted by stopping of the wiper 4 at the upper edge, forcing the sidewise projections 241 of the flange 240 to separate from the fit grooves 261 of the driven gear 26. Then the rotary shaft 24 is pushed forward to compress the coiled spring 25, as shown in FIG. 8, so the connect rod 3 may move the wiper 4 forward, separating the wiper 4 from the surface of the mirror body 11, and then a gap 5 may be formed between the wiping surface 41 of the wiper 4 and the surface of the mirror body 11. In this way, the wiper 4 does not always contact the mirror body 11 so that the wiper 4 never glues with the mirror body 11, preventing the wiper 4 from softening or releasing greasy substance to immerse in the caterpillar holes of the mirror body 11. Then the mirror body 11 can keep its surface always brilliant and clear, with its service life becoming longer.

Next, if the wiper 4 is wanted to be used again, start the motor 22, then the driven gear 26 will begin to function by operation of the transmitting device 2, with the fit grooves 261 fitting with the sidewise projections 241 of the rotary shaft 24, so the rotary shaft 24 may move back to its original position by recovered elasticity of the coiled spring 25, enabling the wiper 4 to contact closely the surface of the mirror body 11 to function again for cleaning off water drops thereon. Thus, the wiper in the present invention is convenient to use.

While the preferred embodiment of the invention has been described above, it will be recognized and understood that various modifications may be made therein and the appended claims are intended to cover all such modifications that may fall within the spirit and scope of the invention.

What is claimed is:

1. A wiper for an automobile rearview mirror comprising:
a rearview mirror provided with a mirror base, and a mirror body fixed on a front side of said mirror base;
a transmitting device fixed on a rear side of said mirror base and composed of a motor having a spindle, a drive worm fixed on said spindle, said drive worm engaging with a speed-changing gear unit, said speed-changing gear unit composed a first shaft, a second shaft, a drive worm gear and a driven worm fixed on said first shaft, said drive worm gear engaging with said drive worm of said motor, driven worm gear and a drive gear fixed on said second shaft, said driven worm gear engaging with said driven worm, said drive gear engaging with said driven gear on said rotary shaft, said rotary shaft having its first end extending through said mirror body;
a connect rod fixed vertically on the first end of said rotary shaft, located on a front side of said mirror body; and,
a wiper fixed on said connect rod, provided with an elastic member inside, having a wiping surface contacting a surface of said mirror body.

2. The wiper for an automobile rearview mirror as claimed in claim 1, wherein said transmitting device is composed of a shell, and a cap closed on an open front vertical side, said shell and said cap have a shaft hole corresponding to each other, said rotary shaft extends in both said shaft holes of said shell and said cap, said shell and said cap further have a position hole corresponding to each other, and a position member is provided in said shell.

3. The wiper for an automobile rearview mirror as claimed in claim 2, wherein said cap is further provided with a stopping block projecting on its outer wall.

4. The wiper for an automobile rearview mirror as claimed in claim 1, wherein said driven gear is provided with a recess, and the recess has plural fit grooves in an inner wall, and said rotary shaft further has a flange formed in an intermediate portion, said flange provided with plural sidewise projections on one side, and a coiled spring fits around said rotary shaft behind said flange.

5. The wiper for an automobile rearview mirror as claimed in claim 1, wherein said rotary shaft further has a slot formed on the second end, a stopper is provided with an inner projection, and fitted around the second end of said rotary shaft, with said inner projection fitting movably in said slot.

6. The wiper for an automobile rearview mirror as claimed in claim 1, wherein a position member is fixed around the first end of said rotary shaft.
